(19) United States
(12) Patent Application Publication
(10) Pub. No.: US 2011/0240800 A1
(43) Pub. Date: Oct. 6, 2011

(54) IMPACT ATTENUATION SYSTEM AND METHOD

(76) Inventor: Roy L. Fox, JR., Belleville, WV (US)

(21) Appl. No.: 12/750,921

(22) Filed: Mar. 31, 2010

(51) Int. Cl. B64D 1/14

(52) U.S. Cl. 244/138 R; 244/137.1

(57) ABSTRACT

Methods and systems for impact force attenuation reduce the time, expense, and material utilized in connection with aerial delivery of a payload. An impact attenuation system comprises a first airbag coupled to an aerial delivery platform, a gas source coupled to the first airbag, and a first pressure release valve coupled to the first airbag. Via use of an impact attenuation system, a payload may be more quickly rigged for aerial delivery, and more quickly extracted from an aerial delivery platform subsequent to the airdrop. Additionally, rebound, rollover, and other undesirable ground impact conditions may be reduced and/or eliminated.

### TECHNICAL FIELD

The present disclosure relates to aerial delivery, and particularly to impact attenuation in connection with payloads coming into contact with the ground.

### BACKGROUND

Large aerial delivered packages typically consist of payload (for example, cargo parcels, vehicles, and/or the like) secured to an aerial delivery platform. The common “Type V” aerial delivery platform is generally fabricated with longitudinal stiffeners on the bottom of the platform (typically referred to as roller pads) and flanged side rails with notches which are part of a locking system. When the aerial delivery platform is loaded into an aerial delivery aircraft, for example through an aft facing ramp and door, the roller pads align with sets of rollers in or on the aircraft floor, and the side rail flanges fit inside longitudinally mounted C-channels incorporated into the aircraft. The aircraft C-channels restrict lateral movement of the aerial delivery platform, and they also restrict upward movement of the platform if the aircraft experiences negative G-forces.

Incorporated into the aircraft C-channels are plunger-type mechanisms that can be extended laterally into the flange notches to longitudinally secure the platform in the aircraft until the aerial delivery operation occurs. Once the aerial delivery platform and payload have been extracted from the aft end of the aerial delivery aircraft (for example, by gravity, by an extraction parachute, and/or the like), a recovery parachute system is typically deployed to control the attitude and rate of descent of the aerial delivery platform and payload. However, even though the recovery parachute system greatly reduces the payload rate of descent when compared to the free fall rate of descent, the rate of descent typically remains large enough to allow the payload to be damaged upon impact with the ground, absent additional shock-absorbing measures. Accordingly, improved impact attenuation systems and methods are desirable.

### SUMMARY

The present disclosure relates to systems and methods for impact attenuation. In an exemplary embodiment, an impact attenuation system comprises a first airbag coupled to an aerial delivery platform, a gas source coupled to the first airbag, and a first pressure release valve coupled to the first airbag.

In another exemplary embodiment, a method for attenuating an impact of an aerial delivery system comprises deploying an aerial delivery platform from a cargo aircraft, at least partially inflating a first airbag beneath the aerial delivery platform, and, responsive to impact with the ground, at least partially deflating the first airbag in order to reduce rebound of the aerial delivery platform.

In another exemplary embodiment, an aerial delivery platform comprises a plurality of platform panels and a plurality of roller pads. Each of the plurality of roller pads has a height in excess of 2 inches in order to provide storage space for at least a portion of an impact attenuation system therebetween. The aerial delivery platform further comprises a pair of side rails disposed on opposing sides of the aerial delivery platform, each of the side rails configured with notches at a height configured to preserve compatibility with existing cargo aircraft mounting components. The aerial delivery platform further comprises an extraction force transfer coupling coupled to one end of the aerial delivery platform by a pivot, wherein the extraction force transfer coupling does not contact the floor of the cargo aircraft responsive to a force on the extraction force transfer coupling from deployment of an extraction parachute.

The contents of this summary section are provided only as a simplified introduction to the disclosure, and are not intended to be used to limit the scope of the appended claims.

### BRIEF DESCRIPTION OF THE DRAWINGS

With reference to the following description, appended claims, and accompanying drawings:

FIG. 1A illustrates a Type V aerial delivery platform;

FIG. 1B illustrates a close-up view of a portion of a Type V aerial delivery platform;

FIG. 1C illustrates a payload coupled to a Type V aerial delivery platform with crushable material located therebetween;

FIG. 1D illustrates a block diagram of an impact attenuation system in accordance with various exemplary embodiments;

FIG. 1E illustrates an end view of an aerial delivery platform in accordance with various exemplary embodiments;

FIG. 2A illustrates components of an impact attenuation system in accordance with an exemplary embodiment;

FIG. 2B illustrates an application of an impact attenuation system in accordance with an exemplary embodiment;

FIG. 2C illustrates an inflation component of an impact attenuation system having multiple airbags in accordance with an exemplary embodiment;

FIG. 2D illustrates an impact attenuation system with a deployed air bag in accordance with various exemplary embodiments;

FIG. 2E illustrates various configurations of air bags in accordance with an exemplary embodiment;

FIG. 2F illustrates active deflation components of an impact attenuation system in connection with an aerial delivery platform in accordance with an exemplary embodiment;

FIGS. 2G-2H illustrate impact attenuation systems incorporating bottom plates in accordance with various exemplary embodiments;

FIG. 2I illustrates components of an impact attenuation system including reinforcing members in accordance with various exemplary embodiments;

FIG. 3 illustrates various retaining approaches for an impact attenuation system to an aerial delivery platform in accordance with various exemplary embodiments;

FIGS. 4A-4B illustrate various configurations of an aerial delivery platform having additional storage room for an impact attenuation system in accordance with various exemplary embodiments; and

FIG. 4C illustrates an extraction force transfer coupling coupled to a height modified aerial delivery platform in accordance with an exemplary embodiment.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

For the sake of brevity, conventional techniques for aerial delivery, cushioning, impact force attenuation, parachute operation, pressure sensing, and/or the like may not be described in detail herein. Furthermore, the connecting lines shown in various figures contained herein are intended to represent exemplary functional relationships and/or physical couplings between various elements. It should be noted that many alternative or additional functional relationships and/or physical connections may be present in a practical impact attenuation system.

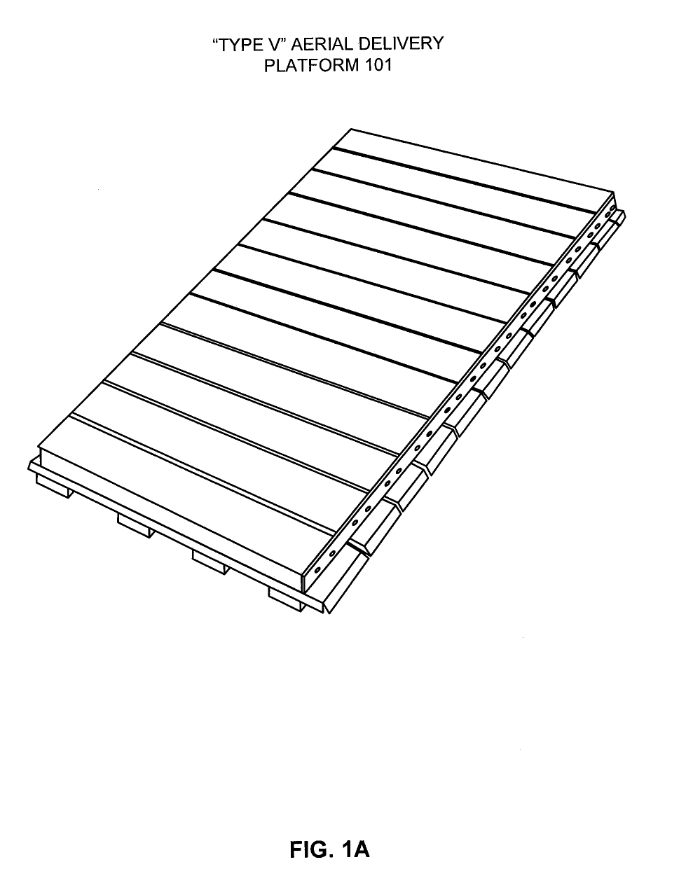

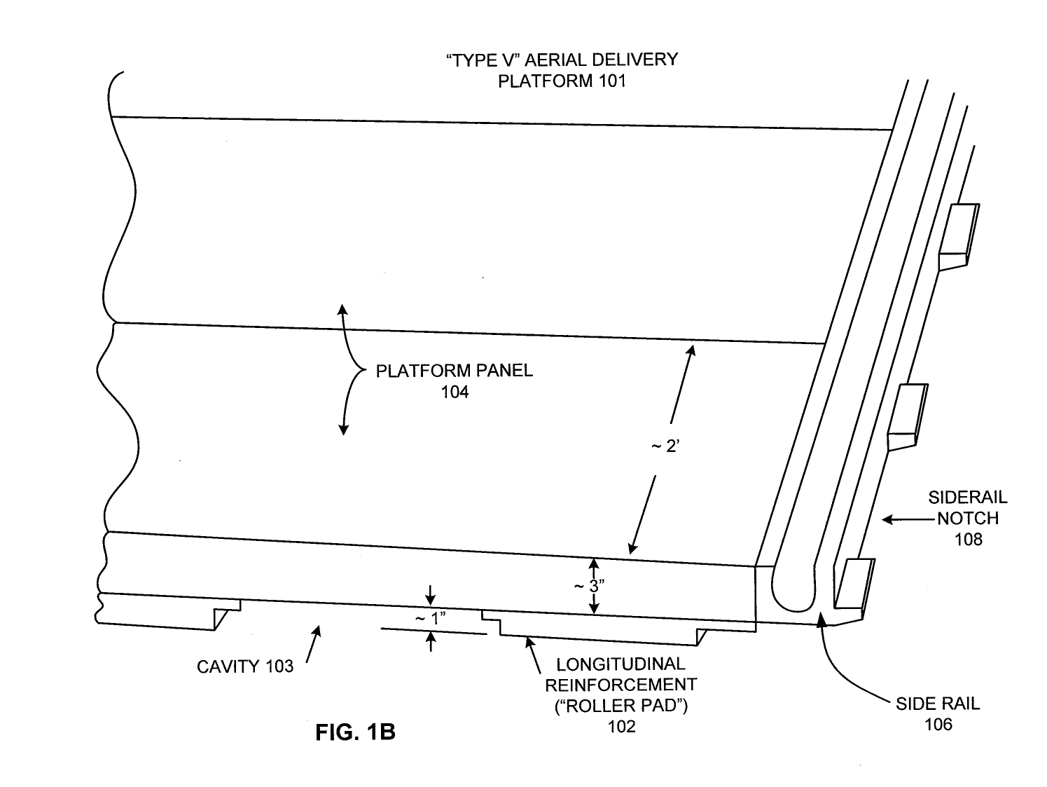

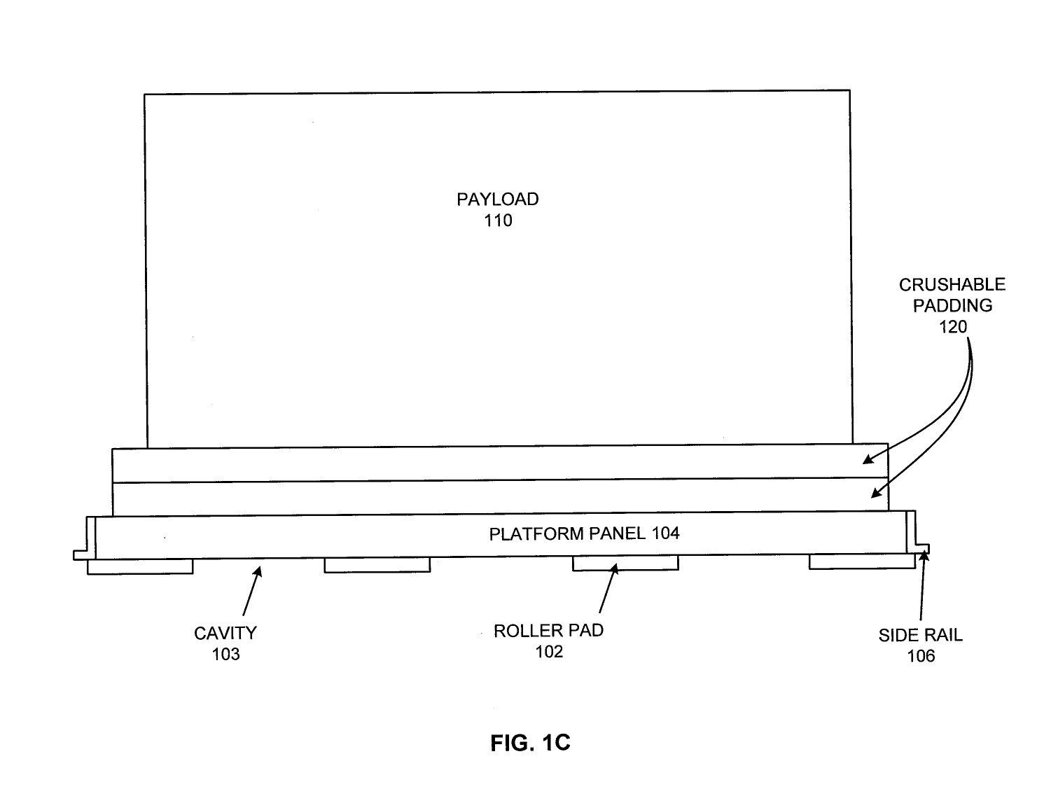

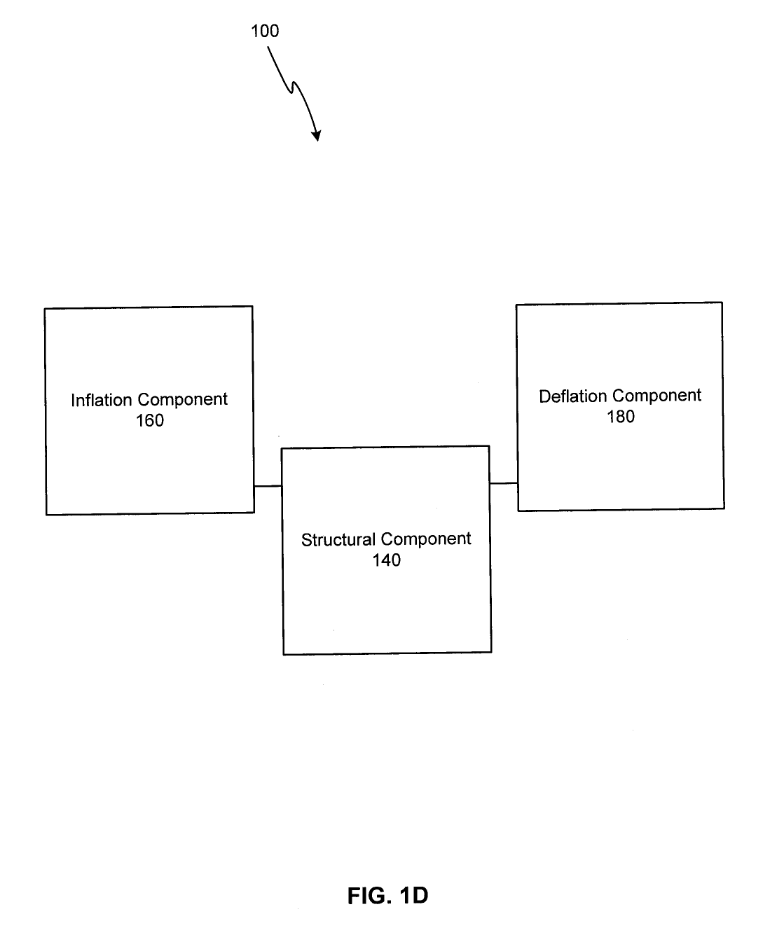

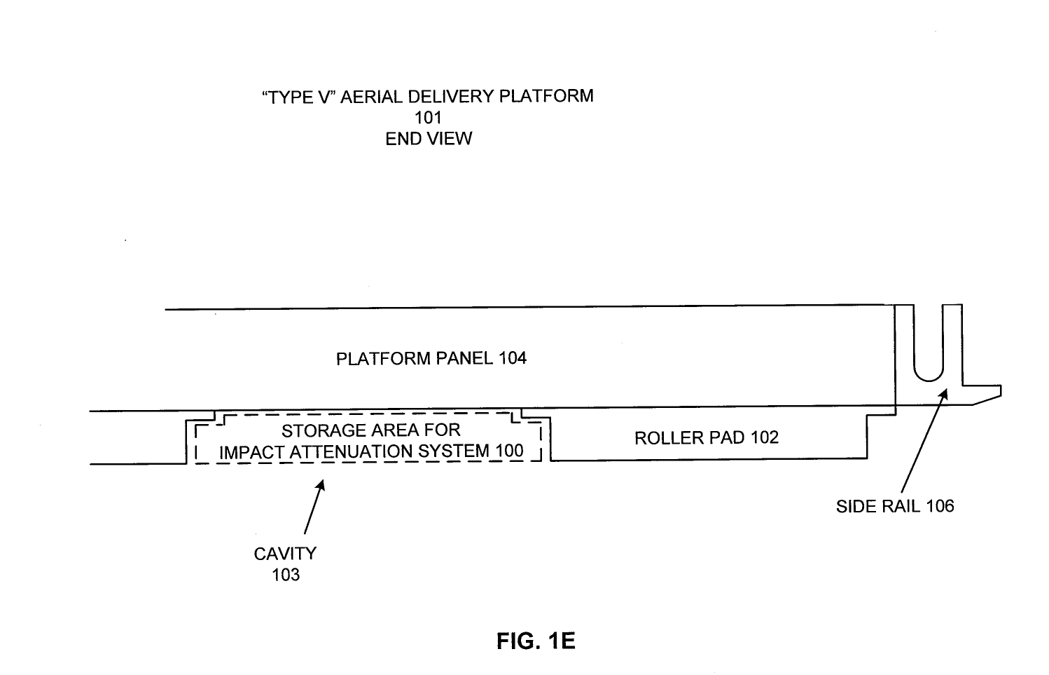

An aerial delivery platform, for example a typical Type V aerial delivery platform 101 illustrated in FIGS. 1A-1B, often utilizes padding to reduce the impact force when a payload contacts the ground. With reference to FIG. 1B, an exemplary Type V aerial delivery platform 101 comprises a plurality of platform panels 104 adjacent to one another. Platform panels 104 may be any suitable dimension, but are commonly about 2 feet in width and about 3 inches in height. Coupled to platform panels 104 are a plurality of longitudinal reinforcements, for example roller pads 102. Roller pads 102 may be configured with any suitable dimensions, but are commonly about 1 inch in height. Roller pads 102 are spaced at intervals such that one or more cavities 103 are created therebetween. Along two sides of aerial delivery platform 101 are disposed two side rails 106 including side rail notches 108. Side rails 106 and side rail notches 108 are configured to allow aerial delivery platform 101 to interface with mounting and deployment systems in cargo aircraft.

With reference now to FIG. 1C, a crushable padding 120 is commonly installed between the top of aerial delivery platform 101 and the bottom of a payload 110. Crushable padding 120 often consists of one or more layers of patterned material, for example paper honeycomb material, which becomes crushed to some degree at landing.

Suitably sized paper honeycomb functions as a padding, acting as an impact-force attenuating material by crushing. As a result of being crushed instead of being compressed, the honeycomb material stores only a small amount of energy to cause rebound. However, the honeycomb material is costly. Moreover, it is not reusable, and often needs to be recovered and/or disposed of. Further, because aerial delivery aircraft have inherent cargo compartment height limitations resulting from the dimensions of the fuselage, the maximum payload height is also limited. By adding paper honeycomb between an aerial delivery platform and a payload, the available payload height is further limited. Additionally, when paper honeycomb is used as an impact-force attenuator beneath certain payloads, for example vehicles, additional problems are often encountered at landing. For example, the honeycomb may crush unevenly and/or become crammed up into the vehicle undercarriage. This can require a significant amount of labor, or even mechanical lifting means, in order to release the vehicle from the honeycomb and free it from the aerial delivery platform.

To address the reusability and/or disposability issues of the paper honeycomb, there have been numerous attempts to utilize suitable alternative materials. Typically, these alternative materials have comprised, at least in part, synthetic rubber based materials. As a result, the alternative materials have compressed upon impact, at least partially storing the impact energy. The alternative materials then at least partially rebound. The rebound force oftentimes flips the platform/payload assembly onto its side or completely upside down, potentially resulting in significant damage to the payload. Additionally, these alternative materials generally offer little to no advantage relative to the typically utilized paper honeycomb material with respect to payload height restrictions.

In contrast, payload height restrictions, impact rebound, and/or other undesirable limitations of prior shock-absorbing techniques, methods, components, and/or systems may suitably be addressed by use of an impact attenuation system and methods in accordance with principles of the present disclosure.

An impact attenuation system may be any system configured to at least partially absorb, reduce, and/or otherwise mitigate or control impact forces, for example impact forces resulting from a payload descending under a parachute coming into contact with the ground. With reference now to FIG. 1D, in accordance with various exemplary embodiments an impact attenuation system 100 generally comprises a structural component 140, an inflation component 160, and a deflation component 180. Structural component 140 can comprise an airbag, bladder, skirt, or other at least partially inflatable and/or deflatable component configured to at least partially absorb impact forces, for example forces resulting from contact with the ground.

Inflation component 160 is coupled to structural component 140. Inflation component 160 may comprise a one-way valve, a compressed air container, an air compressor, a chemical-energy pyrotechnic device, or other suitable component or combinations thereof configured to at least partially inflate, expand, guide and/or otherwise configure structural component 140 prior to and/or during impact with the ground.

Deflation component 180 is coupled to structural component 140 and/or inflation component 160. Deflation component 180 may comprise rupture panels, cutters, pressure release valves, and/or the like or combinations thereof, and is configured to at least partially deflate, shrink, guide, and or otherwise configure structural component 140 prior to, during, and/or after impact with the ground.

In various exemplary embodiments, impact attenuation system 100 is configured to be retrofittable to various existing Type V aerial delivery platforms. For example, with reference now to FIG. 1E, impact attenuation system 100 (or a portion thereof) is configured to be disposed in cavity 103 between roller pads 102 of aerial delivery platform 101.

In other exemplary embodiments, impact attenuation system 100 is configured to be utilized with customized Type V aerial delivery platforms, for example Type V aerial delivery platforms having modified-height roller pads and/or modified side rails to allow compatibility with existing cargo aircraft mounting and deployment systems.

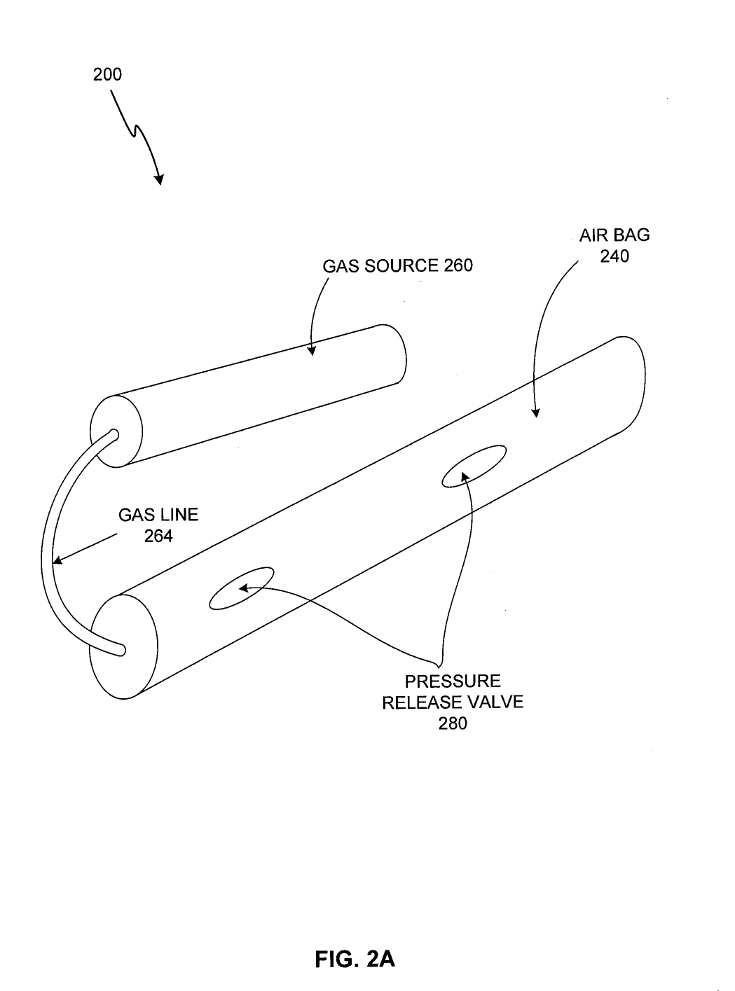

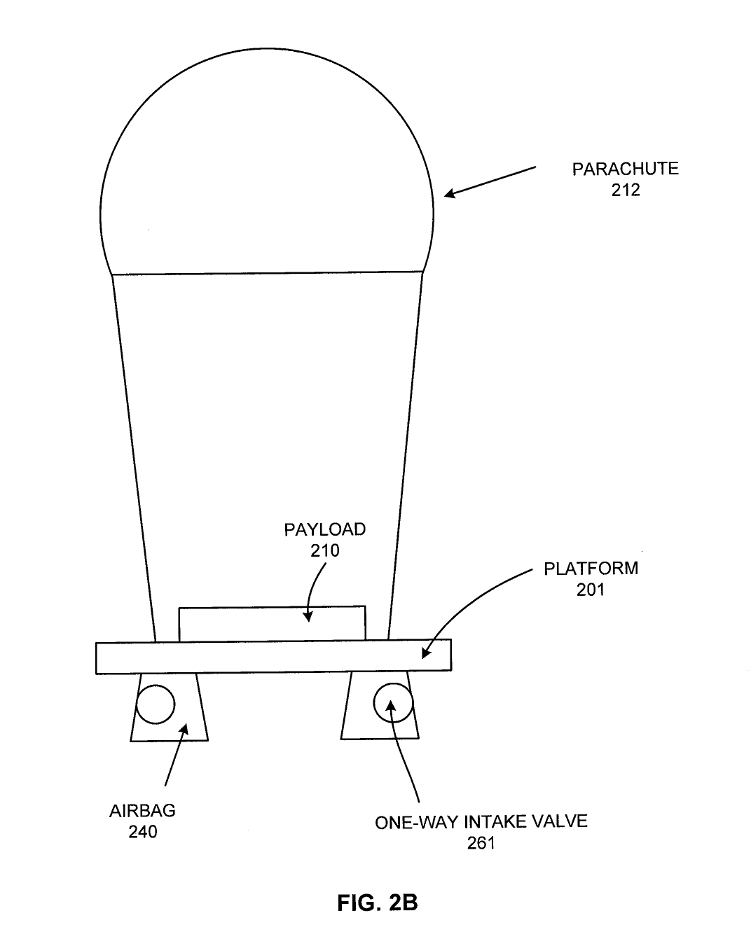

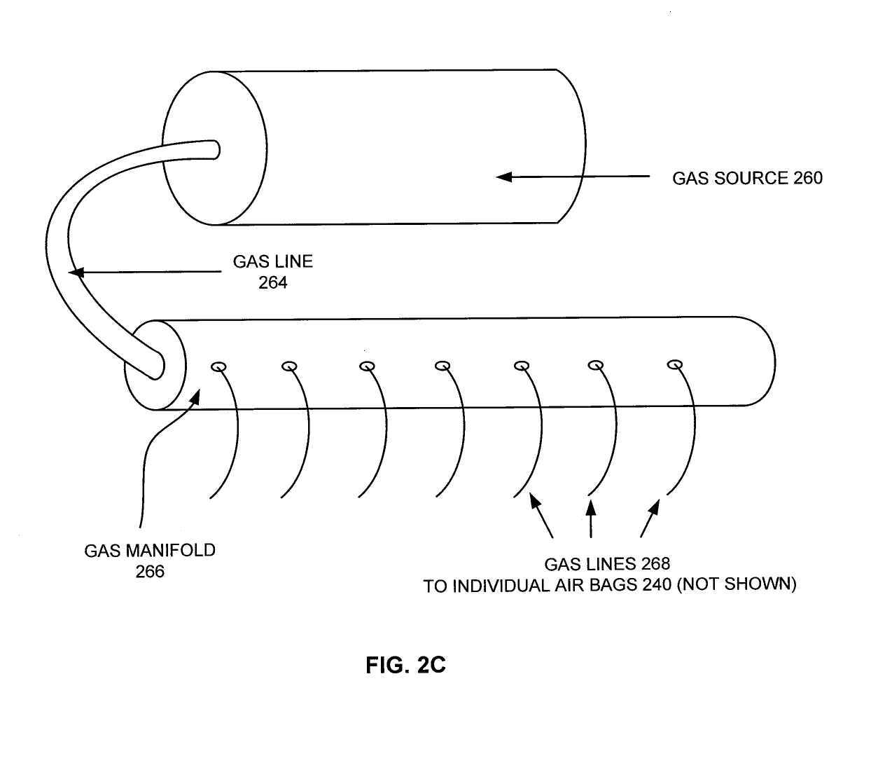

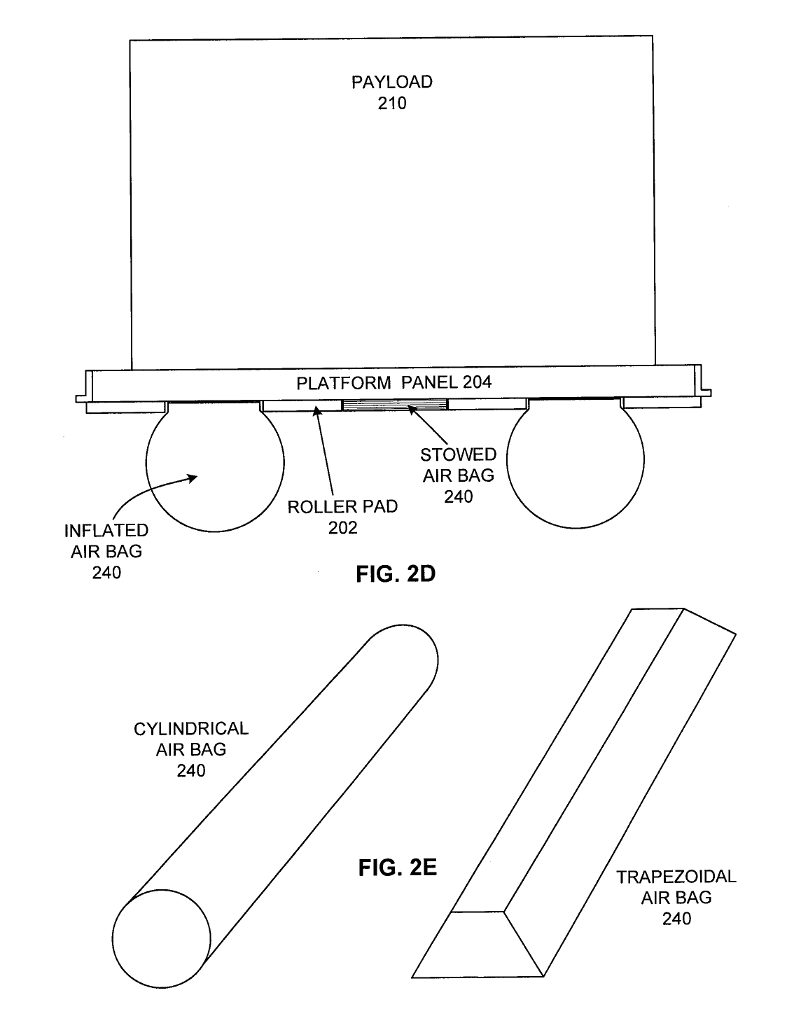

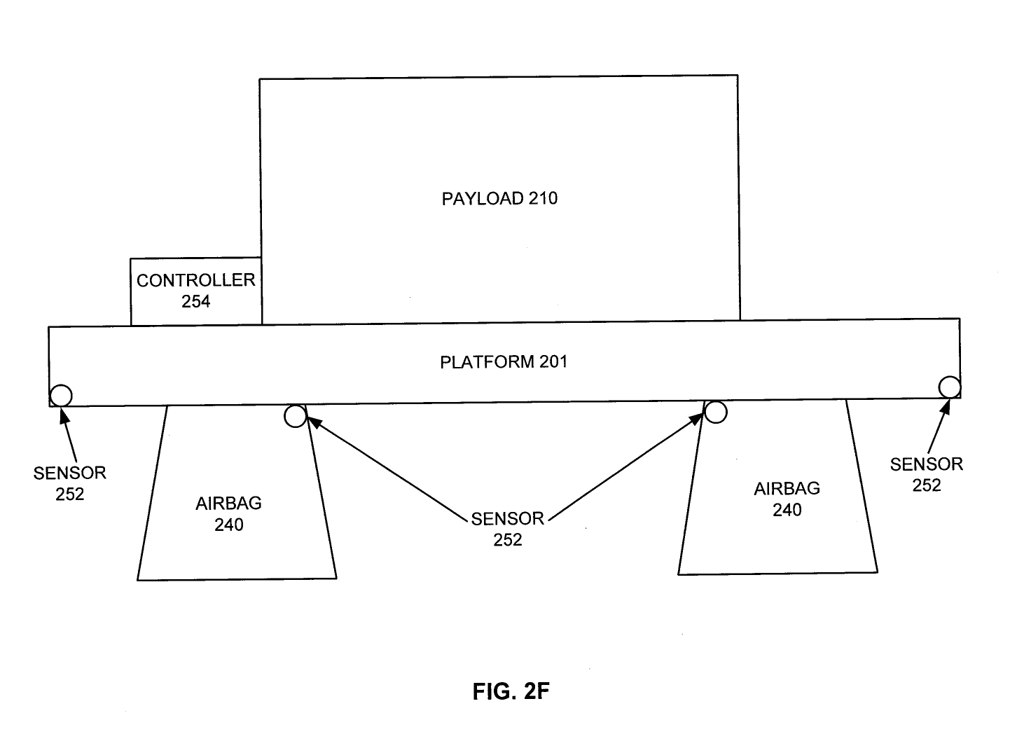

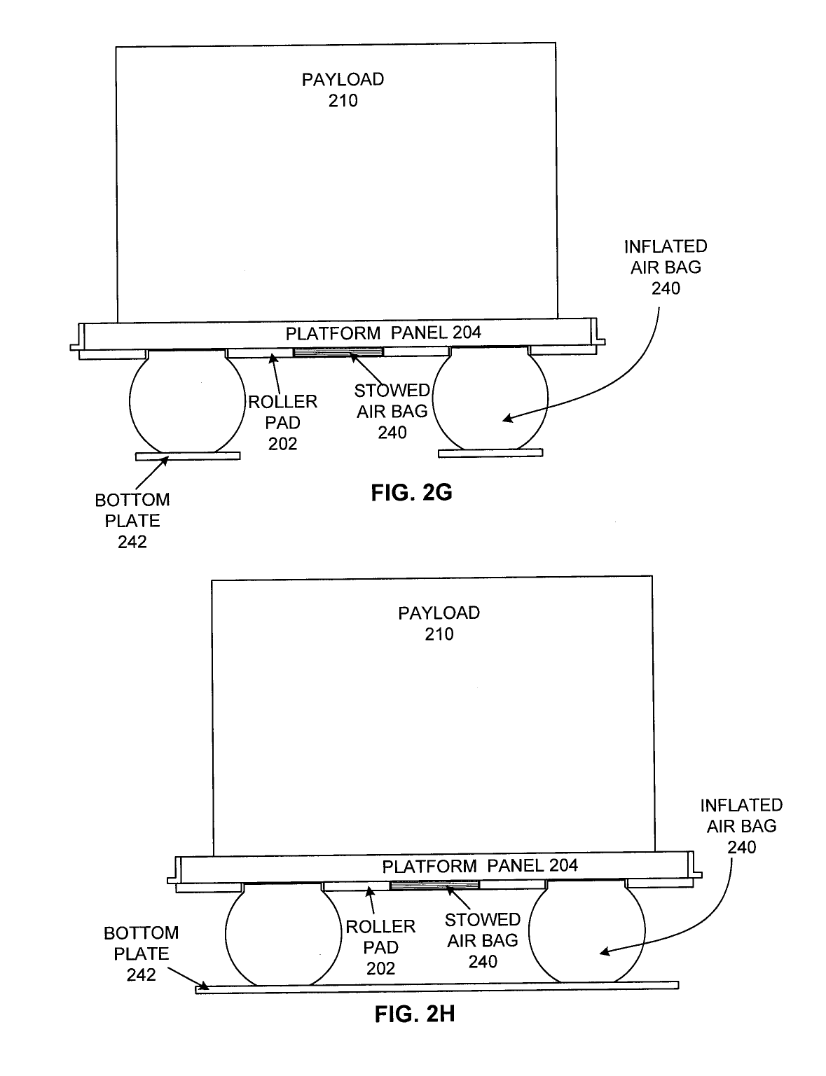

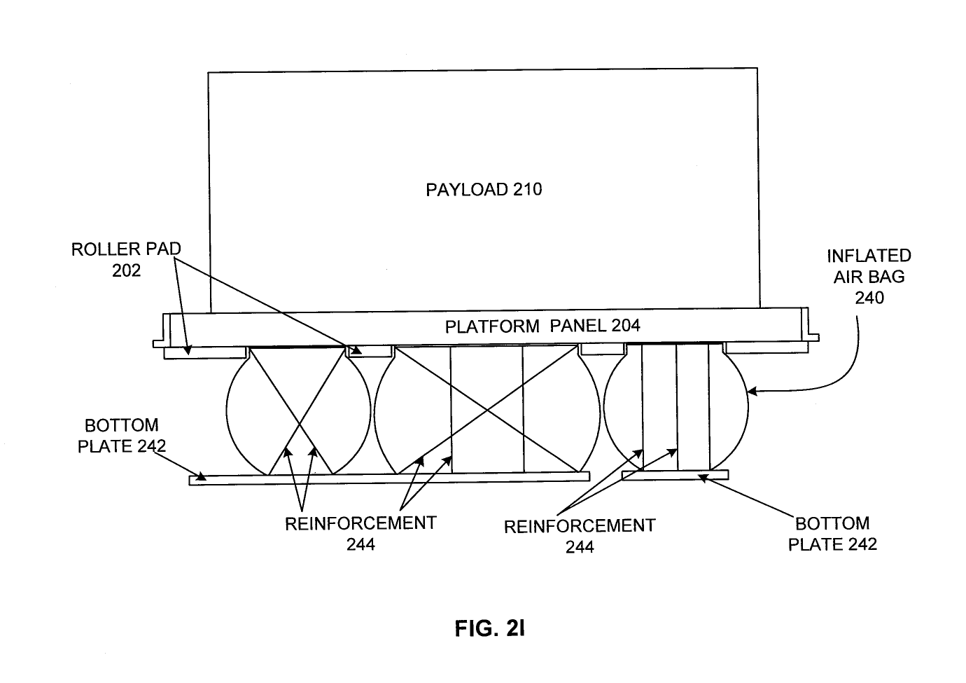

Moreover, impact attenuation system 100 may be configured with any appropriate components and/or elements configured to at least partially absorb, reduce, and/or otherwise mitigate or control impact forces associated with a payload descending under a parachute. With reference now to FIG. 2A, and in accordance with an exemplary embodiment, an impact attenuation system 100 (for example, impact attenuation system 200) comprises structural component 140 (for example, airbag 240), inflation component 160 (for example, gas source 260), and deflation component 180 (for example, pressure release valve 280). Impact attenuation system 200 may be coupled to an aerial delivery platform in order to at least partially cushion and/or attenuate impact forces exerted on the platform and/or associated payload.

Airbag 240 may comprise any suitable material and/or components configured to at least partially absorb, cushion, and/or mitigate an impact force. In an exemplary embodiment, airbag 240 comprises a substantially impermeable fabric or membrane, for example nylon, polyethylene terephthalate (e.g., Dacron®), ultra-high molecular weight polyethelyne (e.g., Spectra®), poly paraphenylene terephthalamide (e.g., Kevlar®), and/or other high-modulus aramid fibers, and/or the like, or combinations thereof. Airbag 240 is configured to be inflatable in order to at least partially mitigate the effects of an impact.

Airbag 240 may be configured with any suitable shapes, sizes, and/or geometries, either when collapsed or inflated, in order to couple to and/or cushion an aerial delivery platform from an impact. In an exemplary embodiment, airbag 240 is generally cylindrical and has a diameter of between about 12 inches and about 48 inches. In an exemplary embodiment, airbag 240 extends substantially the same length as a coupled aerial delivery platform. In various exemplary embodiments, and with reference to FIGS. 2D and 2E, airbag 240 may be mounted on the bottom of an aerial delivery platform. Airbag 240 may be configured with a cylindrical shape, a trapezoidal shape, a rectangular shape, and/or any other suitable shape in order to allow airbag 240 to extend below the bottom of an aerial delivery platform when airbag 240 is at least partially inflated. In this manner, as the aerial delivery platform descends toward the ground, airbag 240 touches the ground first and absorbs a portion of the impact force.

In various exemplary embodiments, with reference now to FIG. 2G, airbag 240 may be configured with and/or coupled to a rigid or semi-rigid portion, for example a bottom plate 242. Bottom plate 242 may be more resistant to puncture than the remainder of airbag 240. Thus, airbag 240 may be less likely to rupture when contacting rough and/or uneven terrain or vegetation. Additionally, bottom plate 242 can reduce sagging of airbag 240 below the aerial delivery platform when airbag 240 is in an uninflated condition. In various exemplary embodiments, bottom plate 242 comprises one or more of aluminum, titanium, steel, high-density polyethelyne (HDPE), plastic, lumber, fiber-reinforced plastic, and/or combinations of the same.

In certain exemplary embodiments, with reference now to FIGS. 2H and 2I, bottom plate 242 may be coupled a single airbag 240 or to multiple airbags 240. In these embodiments, bottom plate 242 may extend between and/or beyond one or more airbags 240. Moreover, bottom plate 242 may extend substantially the full width and/or length of platform panel 204 and/or aerial delivery platform 201. Bottom plate 242 may also be configured to assist in retaining airbag 240 in a stowed position prior to activation of airbag 240. For example, bottom plate 242 may be configured with protrusions or “tangs” which may engage with cavities in the side of roller pads 202. As airbag 240 is inflated, bottom plate 242 may at least partially deform and disengage from roller pads 202, allowing airbag 240 to fully inflate. Additionally, airbag 240 may further comprise a top plate (not shown) disposed between airbag 240 and aerial delivery platform 201.

Turning to FIG. 2I, in various exemplary embodiments airbag 240 may be configured to generally hold a desired shape and/or resist “rolling,” for example responsive to horizontal velocity of aerial delivery platform 201 upon contact with the ground. Accordingly, in certain exemplary embodiments, airbag 240 is configured with one or more reinforcements 244. Reinforcements 244 may comprise any suitable components configured to provide structural stability to airbag 240. In an exemplary embodiment, reinforcements 244 comprise cordage. In another exemplary embodiment, reinforcements 244 comprise wire. In yet another exemplary embodiment, reinforcements 244 comprise panels. Moreover, reinforcements 244 may comprise any suitable material, components, and/or combinations thereof configured to provide structural support to airbag 240 when airbag 240 is at least partially inflated. Moreover, reinforcements 244 may be configured vertically, diagonally, and/or at any suitable angle and/or orientation, as desired. Reinforcements 244 may be located internal to airbag 240; alternatively, reinforcements 244 may be located external to airbag 240.

In certain exemplary embodiments, airbag 240 may be reusable. In other exemplary embodiments, airbag 240 may be configured for one-time use. Moreover, portions of impact attenuation system 200 (for example, bottom plate 242) may be reusable, while other portions (for example, airbag 240) may be configured for one-time use.

In various exemplary embodiments, airbag 240 comprises a closed cavity bag capable of holding positive pressure (i.e., pressure greater than the ambient atmosphere). In other exemplary embodiments, airbag 240 comprises a bag having an at least partially open bottom (somewhat similar to a lampshade having a sealed top) whereby the ground at least partially seals airbag 240 upon contact.

With reference again to FIGS. 1D-2B, inflation component 160 may comprise any suitable components, devices, systems, and/or combinations thereof configured to at least partially inflate structural component 140. In an exemplary embodiment, with reference now to FIG. 2A, inflation component 160 comprises gas source 260 and gas line 264. Gas source 260 may comprise a compressed air container, an air compressor, a chemical-energy pyrotechnic device (for example, a sodium azide device similar to devices utilized for inflation of automotive airbags), and/or any other suitable components and/or controls therefor configured to at least partially inflate airbag 240. Gas source 260 delivers gas for inflation of airbag 240 via gas line 264.

In an exemplary embodiment, gas source 260 is located within airbag 240. In another exemplary embodiment, gas source 260 is located adjacent to airbag 240. Moreover, gas source 260 may be located in any suitable location and/or arrangement in order to allow gas source 260 to at least partially inflate one or more airbags 240.

For example, in various exemplary embodiments a single gas source 260 may be configured to at least partially inflate a plurality of airbags 240. With reference to FIG. 2C, gas source 260 may be coupled via gas line 264 to gas manifold 266. From gas manifold 266, gas lines 268 extend to a plurality of airbags 240. In this manner, a single gas source 260 may be utilized for inflation of some or all airbags 240 comprising impact attenuation system 200. Thus, multiple gas sources may not be needed, reducing the expense and/or complexity of the system.

Gas source 260 may be regulated, controlled, and/or otherwise governed, for example by electromechanical control. Additionally, gas source 260 may be configured for remote operation. For example, gas source 260 may be configured with wireless communication components allowing a user to send an operative command to gas source 260, for example an activation command, a flow rate command, a shutoff command, and/or the like. In this manner, a user may monitor a desired parameter, for example the inflation of airbag 240, and may trigger shutoff of gas source 260 once a desired inflation profile for airbag 240 has been achieved. Additionally, a user may monitor the inflation of multiple airbags 240 and/or the operation of multiple gas sources 260, and may trigger operation of one or more gas sources 260 at a desired time. Gas source 260 may also be configured to activate after a predetermined time period after aerial delivery platform 201 is deployed from an aircraft (for example, 2 seconds, 5 seconds, 10 seconds, 30 seconds, and/or the like). Gas source 260 may further be configured to be activated responsive to any suitable condition, for example altitude of a payload, velocity of a payload, atmospheric pressure, temperature, and/or the like, as desired.

With reference now to FIG. 2B, in another exemplary embodiment inflation component 160 comprises one-way intake valve 261. As aerial delivery platform 201 and payload 210 descend under the operation of parachute 212, airbag 240 may be deployed beneath aerial delivery platform 201 and at least partially inflate via operation of one-way intake valve 261. For example, responsive to initial inflation of parachute 212, deceleration forces acting on airbag 240 can cause airbag 240 to be forced at least partially away from aerial delivery platform 201 and thereby ingest ambient air through one-way valve 261. In another example, responsive to gravity acting on the mass of airbag 240, ambient air may be ingested into airbag 240 through one-way valve 261. In yet another example, responsive to aerial delivery platform 201 descending through the atmosphere, airbag 240 may ingest ambient air through one-way valve 261 due to the velocity of air moving across the surface of airbag 240.

In various exemplary embodiments, airbag 240 may be configured with gas source 260 and one-way intake valve 261. In these embodiments, airbag 240 may initially be partially inflated via operation of one-way intake valve 261. Gas source 260 may be used to supplement inflation of airbag 240 in order to achieve a desired inflation level of airbag 240.

In an exemplary embodiment, prior to inflation airbag 240 is held in a first position (for example, a compressed, uninflated position). Responsive to inflation, airbag 240 may assume a second position (for example, a position at least partially extended beyond and/or below the bottom of aerial delivery platform 201). After inflation, airbag 240 may be at least partially deflated and/or returned to the first position, for example via operation of deflation component 180.

Deflation component 180 may comprise any suitable components, devices, and/or systems configured to at least partially reduce the inflation of and/or pressure within structural component 140, for example airbag 240. In an exemplary embodiment, deflation component 180 comprises one or more rupture panels on the sidewall of airbag 240. In another exemplary embodiment, deflation component 180 comprises a cutter configured to puncture airbag 240, for example an explosively powered cutter.

In another exemplary embodiment, with reference again to FIG. 2A, deflation component 180 comprises one or more pressure release valves 280 coupled to airbag 240. Pressure release valve 280 may comprise a spring-loaded valve, a snap-action valve, a diaphragm valve, a valve with adjustable blowdown, and/or any other suitable pressure release valve or similar components as known in the art. In an exemplary embodiment, pressure release valve 280 is configured with a set pressure of 25 pounds per square inch (PSI). In various exemplary embodiments, pressure release valve 280 is configured with a set pressure of between about 10 PSI and about 40 PSI. Moreover, pressure release valve 280 may be configured with any suitable set pressure in order to at least partially deflate airbag 240 at a desired time (for example, responsive to impact with the ground) and thus reduce rebound and/or other undesirable effects.

Moreover, in various exemplary embodiments a plurality of pressure release valves 280 are coupled to airbag 240. Each of the pressure release valves 280 may be configured with a different set pressure, a different gas flow rate, and/or the like. For example, a first pressure release valve 280 may be configured with a set pressure of 15 PSI, a second pressure release valve 280 may be configured with a set pressure of 20 PSI, a third pressure release valve may be configured with a set pressure of 25 PSI, and so forth. In this manner, the response of airbag 240 to an impact force may be modulated and/or otherwise controlled. For example, in one exemplary impact scenario, when airbag 240 impacts the ground beneath aerial delivery platform 201 at a descent velocity X, pressure in airbag 240 may exceed 15 PSI, causing the first pressure release valve 280 to open and partially deflate airbag 240 in order to reduce rebound. In another exemplary impact scenario, airbag 240 may impact the ground beneath aerial delivery platform 201 at a descent velocity 2X, causing pressure in airbag 240 to exceed 20 PSI. Thus, first and second pressure release valves 280 open and partially deflate airbag 240 at an increased rate compared to operation of first pressure release valve 280 alone. In this manner, the timing and/or rate of deflation of airbag 240 may be controlled in order to reduce rebound.

Airbag 240 may be configured with any suitable number and/or type of pressure release valves 280 responsive to any suitable factors, for example a maximum operating pressure of airbag 240, a desired rate of deflation of airbag 240, the size of aerial delivery platform 201, the mass of a payload coupled to aerial delivery platform 201, a size of a parachute or parachutes associated with aerial delivery platform 201, an anticipated rate of descent of aerial delivery platform 201, a measured rate of descent of aerial delivery platform 201, a terrain on which aerial delivery platform 100 is to be dropped, and/or the like.

Aerial delivery platforms, such as aerial delivery platform 201, commonly have some horizontal velocity at touchdown with the ground, for example due to wind drift, oscillations with respect to the vertical axis of the aerial delivery platform, and/or the like. Thus, certain portions of aerial delivery platform 201 (for example, a leading edge) may experience higher impact forces than other portions of aerial delivery platform 201. Additionally, aerial delivery platform 201 may touch down on terrain which is not entirely level or entirely flat. Again, certain portions of aerial delivery platform 201 (for example, a portion immediately above a protruding rock) may experience higher impact forces. Prior impact attenuation approaches, for example use of crushable honeycomb padding, generally resulted in more crushing in the area of higher impact force.

However, if aerial delivery platform 201 touches down with significant horizontal velocity (for example, horizontal velocity exceeding about 10 meters per second) and the crushable material towards the leading edge crushes, aerial delivery platform 201 is likely to roll over. This is due in part to, responsive to the crushing, the center of gravity of the payload and aerial delivery platform 201 shifting in the direction of the horizontal velocity. The effect may be considered akin to a motor vehicle having tires blow out on a turn. If the tires on the outside of the turn blow out, the motor vehicle is more likely to roll over than if the tires on the inside of the turn blow out. Crushable padding influences rough terrain landing of aerial delivery platform 201 in a similar manner.

Similarly, it is not uncommon for the downhill side of aerial delivery platform 201 to experience more crushing of crushable padding than the uphill side. Again, the unequal crushing results in an increased likelihood of downhill rollover. Moreover, removing the payload from aerial delivery platform 201 is generally more difficult when the crushable padding has not compressed evenly.

In various exemplary embodiments, impact attenuation system 100 may function in a passive manner, wherein deflation components 180 are activated responsive solely to pressure resulting from impact with the ground. However, such a passive system may result in similar behavior as experienced with crushable padding, namely that air bags on the leading edge and/or downhill side of aerial delivery platform 201 may at least partially deflate first, increasing the likelihood of rollover.

In various other exemplary embodiments, with reference now to FIGS. 2A and 2F, impact attenuation system 200 may incorporate one or more active deflation components. Via use of active deflation components, impact attenuation system 200 may further reduce the risk of rebound and/or rollover. For example, impact attenuation system 200 may strategically deflate one or more air bags 240 before another airbag 240 in order to keep aerial delivery platform 201 more level.

In an exemplary embodiment, active deflation components comprise one or more sensors 252 coupled to a controller 254. Sensors 252 may be wirelessly coupled to controller 254; alternatively, sensors 252 may be wired to controller 254. Sensors 252 may be battery powered; alternatively, sensors 252 may receive operational power from controller 254 via a wired connection. Sensors 252 may comprise accelerometers, pressure sensors, and/or other suitable sensors configured to allow controller 254 to determine one or more characteristics associated with impact attenuation system 200, for example the attitude of aerial delivery platform 201, the center of gravity of a payload 210, and/or the like. Sensors 252 may be disposed in any suitable location relative to impact attenuation system 200, for example within each airbag 240, at the corners of aerial delivery platform 201, in the center of aerial delivery platform 201, along a side of aerial delivery platform 201, on a surface of payload 210, and/or combinations thereof.

In various exemplary embodiments, controller 254 may be any electrical components and/or systems configured to monitor one or more characteristics associated with impact attenuation system 200 and controllably inflate and/or deflate one or more air bags 240 in response thereto. In certain exemplary embodiments, controller 254 comprises a microcontroller, for example a microcontroller from the Texas Instruments brand MSP430 or CC430 families; a microcontroller from the MicroChip brand PIC16 or PIC18 families; or a microcontroller from the Freescale brand MC9 family. In other exemplary embodiments, controller 254 comprises an application specific integrated circuit (ASIC). Controller 254 may be powered via any suitable source, for example a battery.

In an exemplary embodiment, controller 254 is coupled to a plurality of pressure release valves 280. Controller 254 may be coupled to pressure release valves 280 via any suitable mechanism, for example a wired connection, a radio frequency wireless connection, and/or the like. Controller 254 may thus send operational signals to one or more pressure release valves 280. Pressure release valves 280 may be individually powered, for example via a battery; alternatively, pressure release valves 280 may receive operational power over the same coupling which delivers operational signals from controller 254. Based on input from one or more sensors 252, controller 254 sends signals to pressure release valves 280, for example in order to reduce the likelihood of rebound and/or rollover. For example, when aerial delivery platform 201 contacts a sloped portion of ground, controller 254 may first send activation signals to pressure release valves 280 associated with airbags 240 coupled beneath the uphill side of aerial delivery platform 201. Controller 254 may thereafter send activation signals to pressure release valves 280 associated with airbags 240 coupled beneath the downhill side of aerial delivery platform 201. Alternatively, controller 254 may allow pressure release valves 280 on the downhill side to activate manually, for example responsive to a pressure within the corresponding airbags 240. In this manner, airbags 240 on the uphill side of aerial delivery platform 201 may be deflated earlier than airbags 240 on the downhill side, reducing the likelihood of rollover. Stated another way, active deflation components may be configured to provide an improved impact attenuation profile for impact attenuation system 200 when compared to a passive impact attenuation profile. For example, active deflation components can provide a pattern of deflation beginning at the area of lowest impact force and progressing toward the area of highest impact force.

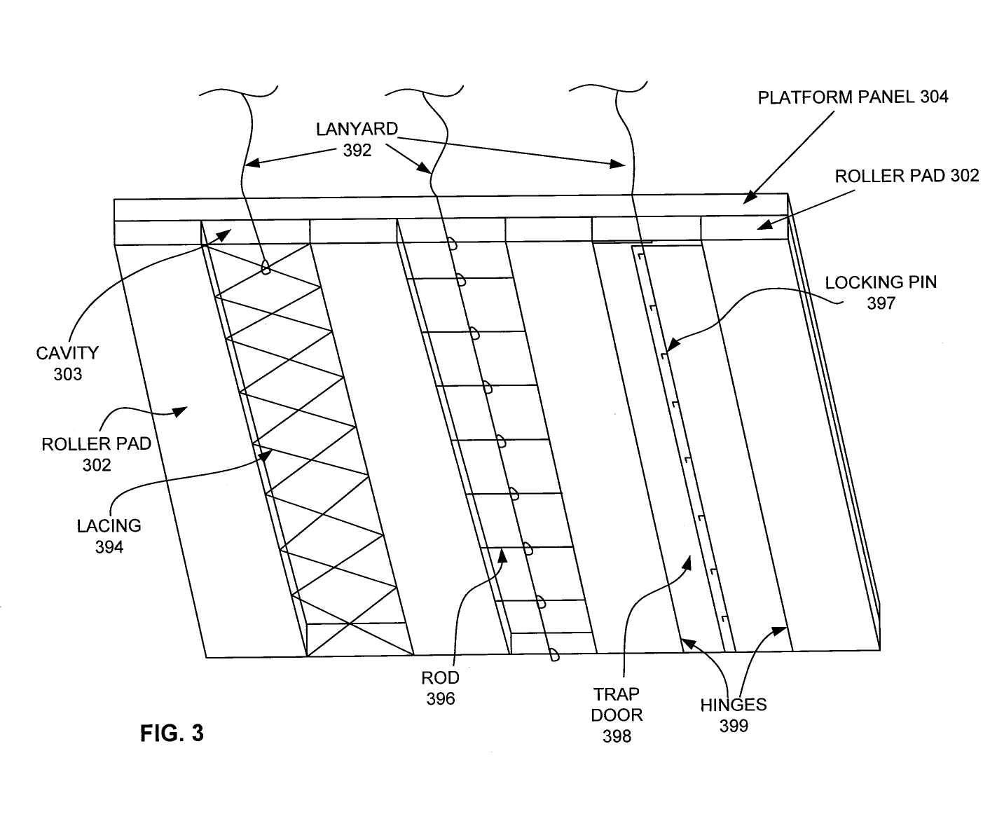

Turning now to FIGS. 2A and 3, impact attenuation system 200 may be releasably coupled to and/or deployed from an aerial delivery platform in any suitable manner. In various exemplary embodiments, at least a portion of impact attenuation system 200 (for example, airbag 240) is placed within cavity 303 located between adjacent roller pads 302. In various exemplary embodiments, airbag 240 is held within cavity 303 by a restraining mechanism. In an exemplary embodiment, airbag 240 is held in place via lacings 394, for example criss-crossing lacings of a high-strength fiber. The lacings may be coupled to a lanyard 392 and/or other suitable mechanism configured to sever and/or unlace lacings 394. Lanyard 392 may be coupled, for example, to a drogue parachute. Responsive to a force, for example a force exerted by lanyard 392 as the drogue parachute separates from the aerial delivery platform, lacings 394 may be severed and/or “unlaced”, allowing airbag 240 to assume an at least partially inflated position.

In another exemplary embodiment, airbag 240 is held in place by a series of semi-flexible and/or rigid rods 396 that bridge the gaps between adjacent roller pads 302. Responsive to a force, for example a force exerted by lanyard 392, rods 396 may be severed and/or decoupled from roller pads 302, allowing airbag 240 to assume an at least partially inflated position.

In yet another exemplary embodiment, airbag 240 is held in place by a one or more trap doors 398 pivoting on hinges 399. Trap doors 398 may be secured to one another via a retaining mechanism, for example a locking pin 397. Responsive to a force, for example a force exerted via lanyard 392, locking pin 397 may be released, allowing trap doors 398 to open and allowing airbag 240 to assume an at least partially inflated position.

In various exemplary embodiments, lanyard 392 may be configured with various loops, pins, and/or other components configured to interface with the restraining mechanism. In this manner, airbag 240 and/or other components of impact attenuation system 200 may be freed from the restraining mechanism and thus a portion of impact attenuation system 200 may inflate below aerial delivery platform 301.

In various exemplary embodiments, airbag 240 may be held in place via hook and loop fasteners (e.g., Velcro® brand material or similar), magnets, mechanical fasteners, frangible links, or any other suitable releasable restraining mechanism or combinations thereof.

In various exemplary embodiments, a restraining mechanism may be released via a pneumatic piston, an electromechanical solenoid, an explosive bolt, a reefing cutter, or any other suitable component configured to release a restraining mechanism. Moreover, a restraining mechanism may be released via remote control, via operation of a timer, and/or responsive to any other suitable condition, as desired. Additionally, a restraining mechanism may be released responsive to a force exerted by inflation of airbag 240 itself. Moreover, a restraining mechanism may be released by the mass of airbag 240 pressing thereon due to a transient deceleration resulting from deployment of a parachute.

In certain exemplary embodiments, impact attenuation system 200 or portions thereof may be located between aerial delivery platform 201 and payload 210. For example, one or more airbags 240 may be located between aerial delivery platform 201 and payload 210. Airbags 240 may be at least partially inflated during descent of aerial delivery platform 201, and may be at least partially deflated responsive to impact with the ground.

In certain exemplary embodiments, impact attenuation system 200 may be utilized with aerial delivery systems that do not utilize Type V aerial delivery platforms. For example, in certain remote sites (e.g., outposts in forward operating areas and the like), Type V or other aerial delivery platforms may be unduly difficult, dangerous, and/or expensive to recover. Accordingly, alternative aerial delivery platforms may be utilized in these instances, and principles of the present disclosure contemplate use of impact attenuation systems of the present disclosure in connection with such alternate aerial delivery platforms and/or components.

In one exemplary embodiment, impact attenuation system 200 may be utilized in connection with a non-reusable plywood and lumber aerial delivery platform. Such a platform generally lacks locking siderails, and thus is typically restrained in an aircraft by retaining straps and/or chains. Impact attenuation system 200 may be coupled to the platform, for example between lumber reinforcement elements on the bottom of the platform. In another exemplary embodiment, impact attenuation system may be utilized in connection with a pallet, for example a 463L pallet often used for aerial transportation purposes. In general, in various exemplary embodiments impact attenuation system 200 may be utilized in connection with aerial delivery platforms formed of metal, lumber, composite (e.g., plywood, plastics, and/or the like) and combinations of the same.

In one exemplary embodiment, impact attenuation system 200 is configured to be utilized in connection with a plywood aerial delivery platform. In this exemplary embodiment, impact attenuation system 200 is configured with a bottom plate 242 extending substantially the same width as the plywood aerial delivery platform. Further, in this exemplary embodiment impact attenuation system 200 may be configured with a single airbag 240, and airbag 240 may be configured with or without reinforcements 244.

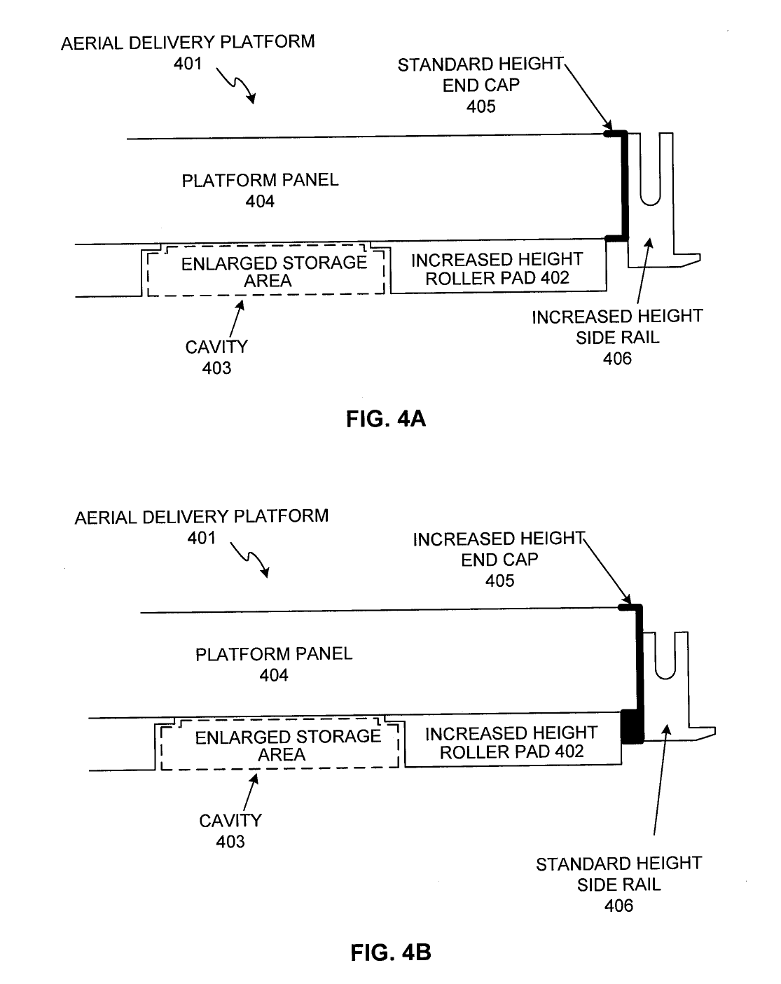

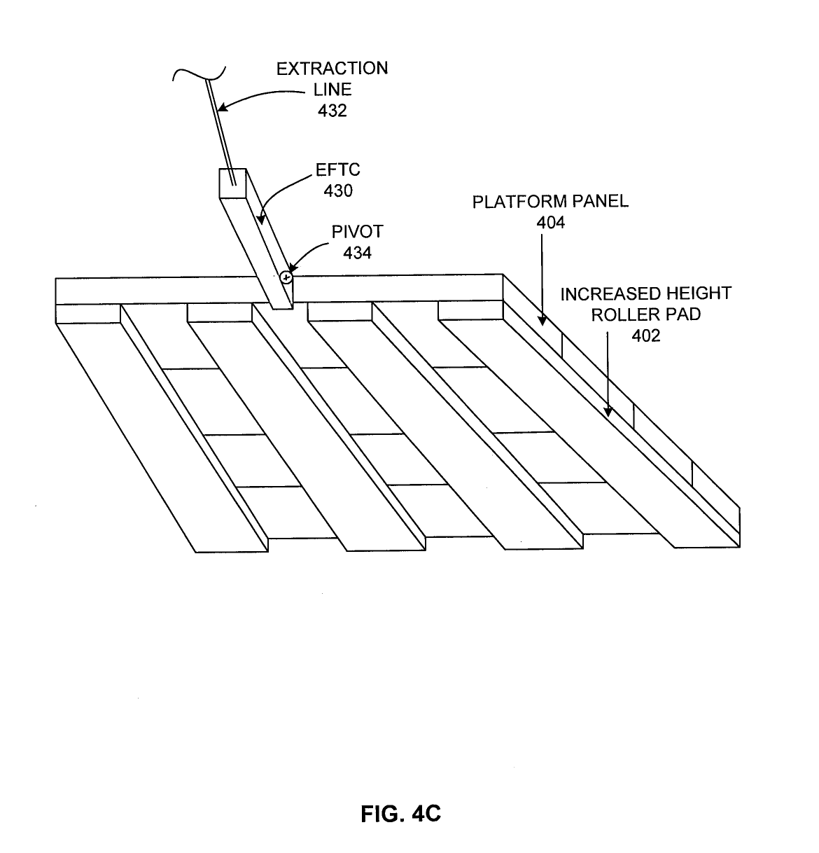

In addition to being suitable for use with aerial delivery platforms of varied construction, in accordance with various exemplary embodiments impact attenuation system 200 is configured to be suitable for use with Type V or similar aerial delivery platforms having roller pads and side rails of various dimensions, including various heights. Turning now to FIG. 4A, in accordance with an exemplary embodiment, additional storage area for at least a portion of impact attenuation system 200 may be provided by modifying a Type V aerial delivery platform, for example aerial delivery platform 401. As previously discussed, many Type V aerial delivery platforms are configured with roller pads of about one inch in height. In contrast, aerial delivery platform 401 is configured with roller pads 402 beneath platform panels 404, wherein roller pads 402 are configured with a height greater than one inch. For example, roller pads 402 may be configured with a height of two inches, two and one-half inches, three inches, three and one-quarter inches, and/or the like. In general, roller pads 402 may be configured with any suitable height between about one (1) inch and about twelve (12) inches. By increasing the height of roller pads 402, the size of cavity 403 is increased, providing for increased storage space for impact attenuation system 200 or portions thereof.

In various exemplary embodiments, with continued reference to FIG. 4A, in order to maintain compatibility with existing guidance and locking systems on cargo aircraft, aerial delivery platform 401 may be further configured with modified-height side rails 406 coupled to end cap 405 of platform panel 404. Side rails 406 are resized such that side rail notches 408 (not shown) remain at their original elevation relative to the bottom surface of roller pads 402. In this manner, side rails 406 and side rail notches 408 are maintained in an appropriate position to engage existing cargo aircraft mounting components.

In other exemplary embodiments, with reference now to FIG. 4B, standard-height side rails 406 may also be employed in connection with roller pads 402. For example, the end cap 405 of platform panel 404 may be extended downward, allowing side rail 406 to be mounted at a suitable position to engage existing cargo aircraft mounting components. Stated another way, end cap 405 may be extended or otherwise configured to compensate for the increased height of roller pads 402.

In addition to roller pads 402 providing increased room for storage of impact attenuation system 200, roller pads 402 can provide additional benefits associated with use of aerial delivery platform 401. Turning now to FIG. 4B, in accordance with an exemplary embodiment aerial delivery platform 401 is coupled to an extraction force transfer coupling (EFTC) 430 via a pivot 434. EFTC 430 is coupled to an extraction line 432, which may be coupled to an extraction parachute (not shown) or other components configured to provide a force to extract aerial delivery platform 401 from the rear of a cargo aircraft.

In general, EFTC 430 comprises a moment arm, for example a moment arm of between about 12 inches and about 24 inches (typically, about 18 inches) in length. EFTC 430 is oriented to face the rear of the cargo aircraft. Pivot 434 is configured to allow EFTC 430 to pivot upward from horizontal, but not downward from horizontal. Thus, when roller pad 402 is about one inch in thickness, EFTC 430 is extended in a horizontal, static position approximately one inch above the aircraft floor. However, inflation of an extraction parachute can be rather dynamic and/or chaotic, leading to significant whipping action in extraction line 432. Thus, when an extraction parachute is deployed, because extraction line 432 is coupled to EFTC 430, EFTC 430 and/or pivot 434 may thus be flexed far enough to cause a portion of EFTC 430 to forcefully contact the aircraft floor, resulting in denting, scraping, gouging, or other damage to the aircraft, particularly during the period subsequent to deployment of an extraction parachute but prior to aerial delivery platform 401 being released from the aircraft locks.

In an exemplary embodiment, by increasing the height of roller pads 402, EFTC 430 is elevated above the aircraft floor by a similar amount, reducing the likelihood of EFTC 430 contacting the aircraft floor during extraction. For example, by utilizing roller pads 402 having a height of three (3) inches, EFTC 430 is elevated above the aircraft floor by three inches, reducing the likelihood of contact.

In various prior approaches for impact attenuation, certain items (for example, vehicles) are airdropped in connection with a rigidizing structure coupling the item to the aerial delivery platform. The rigidizing structure may comprise paper honeycomb, plywood, lumber, and/or the like. The rigidizing structure is intended to ensure that the webbing securing the item to the aerial delivery platform does not become slack. Stated another way, the rigidizing structure is intended to rigidize the association between the item and the aerial delivery platform.

For example, if the item is a vehicle incorporating a suspension system (which can act as a spring), various accelerations during the airdrop process may compress the suspension, allowing a portion of the webbing to become slack. As the suspension rebounds and/or in connection with various other accelerations, the slack in the webbing may be taken up rapidly, and the webbing may at least partially break and/or otherwise fail. In order to reduce the likelihood of this occurrence, a rigidizing structure may be provided. However, the rigidizing structure is typically time-intensive to prepare, and it is also time-intensive to remove once the aerial delivery platform has landed. Thus, both preparing a vehicle for an airdrop and removing a vehicle from an aerial delivery platform after an airdrop may be unduly time-consuming and/or expensive.

Therefore, in addition to impact attenuation between an aerial delivery platform and the ground, principles of the present disclosure contemplate use of impact attenuation components between airdropped items and an associated aerial delivery platform, for example in order to speed the time to rig the payload and the time to de-rig the payload. Turning now to FIG. 5A, in various exemplary embodiments an airbag 540 is disposed between an aerial delivery platform 501 and a payload 510. Airbag 540 is configured to be inflated prior to the airdrop in order to at least partially rigidize the association of payload 510 and aerial delivery platform 501.

Because airdrops are conducted from non-pressurized cargo portions of an aircraft, if airbag 540 is configured with excessive elasticity, airbag 540 will expand when exposed to an atmospheric pressure below the ambient atmospheric pressure present when airbag 540 is initially inflated. Thus, excessively elastic airbag 540 could rupture if not sufficiently strong; alternatively, if excessively elastic airbag 540 is sufficiently strong to resist rupture, it could deform payload 510, deform aerial delivery platform 501, and/or break the webbing coupling payload 510 to aerial delivery platform 501.

Therefore, in various exemplary embodiments airbag 540 may comprise any suitable high tenacity, low modulus material in order to reduce changes in size of airbag 540 responsive to changes in atmospheric pressure. For example, airbag 540 may comprise polyethylene terephthalate (e.g., Dacron®), ultra-high molecular weight polyethelyne (e.g., Spectra®), poly paraphenylene terephthalamide (e.g., Kevlar®), and/or other high-modulus aramid fibers, and/or the like, or combinations thereof.

In an exemplary embodiment, airbag 540 is inflated in order to at least partially rigidize the association between payload 510 and aerial delivery platform 501. Aerial delivery platform 501 may then be deployed from the rear of a cargo aircraft or via other suitable method. Once aerial delivery platform 501 has come to rest on the ground, for example in connection with operation of impact attenuation system 200, airbag 540 may be at least partially deflated. In this manner, the webbing or other securing means coupling payload 510 and aerial delivery platform 501 may become slack, and payload 510 may be more easily separated from aerial delivery platform 501. For example, when payload 510 comprises a vehicle, responsive to deflation of airbag 540 the wheels of the vehicle may engage with aerial delivery platform 501, enabling the vehicle to be driven off aerial delivery platform 501. Because the time to inflate and/or deflate airbag 540 is typically significantly less than the time to install paper honeycomb, plywood, and/or other conventional rigidizing materials, payload 510 may be more quickly prepared for an airdrop and decoupled from aerial delivery platform 501 after landing.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

In the foregoing specification, principles of the present disclosure have been described with reference to various embodiments. However, one of ordinary skill in the art appreciates that various modifications and changes can be made without departing from the scope of the claims below. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

1. An impact attenuation system, comprising:
a first airbag coupled to an aerial delivery platform;
a gas source coupled to the first airbag; and
a first pressure release valve coupled to the first airbag.

2. The system of claim 1, wherein the pressure release valve is activated responsive to impact of the aerial delivery platform with the ground in order to reduce rebound.

3. The system of claim 1, wherein the first airbag is stowed between roller pads of the aerial delivery platform prior to inflation of the airbag.

4. The system of claim 1, wherein the gas source is at least one of: a one-way valve, a compressed gas container, or a sodium azide device.

5. The system of claim 1, further comprising:
a second airbag coupled to the aerial delivery platform; and
a second pressure release valve coupled to the second airbag.

6. The system of claim 1, further comprising:
a first sensor configured to detect a condition associated with the aerial delivery platform and provide a first sensor measurement; and
a controller coupled to the first sensor and to the first pressure release valve, the controller configured to utilize the first sensor measurement to activate the first pressure release valve.

7. The system of claim 6, wherein the condition is at least one of: a pressure in the airbag, a deceleration responsive to an impact, a velocity of the aerial delivery platform, or an attitude of the aerial delivery platform.

8. The system of claim 6, further comprising:
a second airbag coupled to the aerial delivery platform;
a second pressure release valve coupled to the second airbag; and
a second sensor configured to detect a condition associated with the aerial delivery platform and provide a second sensor measurement, wherein the controller utilizes the first sensor measurement and the second sensor measurement to activate the first pressure release valve prior to activating the second pressure release valve.

9. The system of claim 8, wherein the first pressure release valve is activated prior to the second pressure release valve in order to prevent rollover of the aerial delivery platform.

10. The system of claim 8, wherein the first pressure release valve is located uphill from the second pressure release valve when the aerial delivery platform contacts the ground.

11. The system of claim 8, wherein the first pressure release valve is located behind the second pressure release valve with respect to a horizontal velocity of the aerial delivery platform when the aerial delivery platform contacts the ground.

12. The system of claim 1, wherein the airbag is held in an uninflated position by a restraining mechanism, and wherein the restraining mechanism is released by at least one of: a lanyard coupled to a parachute, an inflation force of the airbag, an explosive bolt, a reefing cutter, or a deceleration force from initial inflation of a parachute.

13. The system of claim 1, wherein the impact attenuation system does not reduce the available payload space between the top of the aerial delivery platform and the inner side of a cargo aircraft fuselage.

14. The system of claim 1, wherein the aerial delivery platform is at least one of: a Type V platform, a plywood platform, or a 463L pallet.

15. The system of claim 1, further comprising a second airbag coupled to the aerial delivery platform, wherein the second airbag is inflated between the aerial delivery platform and a payload in order to rigidize the association of the aerial delivery platform and the payload.

16. The system of claim 15, wherein the second airbag is inflated prior to airdrop of the aerial delivery platform.

17. The system of claim 16, wherein the second airbag is deflated responsive to the aerial delivery platform contacting the ground.

18.-22. (canceled)

23. An aerial delivery platform, comprising:
a plurality of platform panels;
a plurality of roller pads, each of the plurality of roller pads having a height in excess of 2 inches in order to provide storage space for at least a portion of an impact attenuation system therebetween;
a pair of side rails disposed on opposing sides of the aerial delivery platform, each of the side rails configured with notches at a height configured to preserve compatibility with existing cargo aircraft mounting components; and
an extraction force transfer coupling coupled to one end of the aerial delivery platform by a pivot, wherein the extraction force transfer coupling does not contact the floor of the cargo aircraft responsive to a force on the extraction force transfer coupling from deployment of an extraction parachute.

24. The aerial delivery platform of claim 24, further comprising an impact attenuation system coupled to the aerial delivery platform, wherein the impact attenuation system comprises:
a first airbag coupled to the aerial delivery platform;
a gas source coupled to the first airbag; and
a first pressure release valve coupled to the first airbag.
